(19) United States
(12) Patent Application Publication
(10) Pub. No.: US 2018/0074607 A1
(43) Pub. Date: Mar. 15, 2018

(54) Portable virtual-reality interactive system

(71) Applicant: Ace Zhang, Herndon, VA (US)

(72) Inventor: Ace Zhang, Herndon, VA (US)

(21) Appl. No.: 15/261,982

(22) Filed: Sep. 11, 2016

(51) Int. Cl. G06F 3/0354; G06F 3/01; G06F 3/0488; G06F 3/042; H04W 4/00; H04M 1/05

(52) U.S. Cl. CPC G06F 3/03547; G06F 3/011; G06F 3/04886; G06F 2203/04102; H04W 4/003; H04M 1/05; G06F 3/0426

(57) ABSTRACT

A portable virtual-reality interactive system includes a computer that is interoperable with a smartphone, a flexible roll-up mat that has an electrically-activated stiffening mechanism and a projector for projecting a virtual keyboard onto the mat. The stiffening mechanism includes embedded coils surrounding a flexible electrical wire. A portion of the mat may be configured to serve as an on-demand workspace for controlling a cursor on the smartphone. A finger cap with a pressure sensor may be used to control a cursor and register mouse clicks. The finger cap may also be used to track movements of a user. A headset may be used, which contains a compartment for the smartphone so that when the headset is worn, the user can see the view screen of the smartphone.

### TECHNICAL FIELD

In the field of computer graphics processing and selective visual display systems, a portable virtual-reality interactive system wherein objects are pictured to show them as they appear to the eye with reference to a relative distance or depth from an imaginary viewpoint behind a smartphone view screen.

### BACKGROUND ART

Fully functional computers require an easy means of data entry, a large monitor so that the user can interact on a detailed level, and a user controlled mouse that can allow the user to interact with the computer through the view screen. Portable computing today includes the laptop and the smartphone. But these devices can be limiting in terms of enabling three dimensional virtual reality, the fixed size of the view screen, the ability to easily enter data, the ability to manipulate objects shown on the screen, and to afford a high degree of cursor control on the screen.

Keyboards are today's most efficient best means for data entry. The larger ones are preferred for most desktops because they are the most versatile. Smaller keyboards on laptops can be constraining because there size is necessarily limited to the size of the laptop. Even smaller data entry typing is possible on smartphones, and these are even more difficult to manipulate because of size and speed limiting data entry correction.

Mouse use has been replaced on many laptops by a touch pad that is controlled by finger positioning. This is not as precise as a desktop mouse but it is a substitute for having to carry around a mouse for user interaction with the computer. Cursor control on a smartphone is again finger controlled by touching the view screen but is again much less precise than a desktop mouse.

### SUMMARY OF INVENTION

A portable virtual-reality interactive system includes a computer having a processor, computer memory, and a video card; a smartphone has a view screen and is interoperable with the computer; a flexible roll-up mat that has an electrically-activated stiffening mechanism made with embedded coils surrounding a flexible electrical wire; and a projector that projects an image of a keyboard on the mat so that the mat can recognize contact with individual keyboard keys shown in the image. The mat may also serve as an on-demand workspace for controlling a cursor on the smartphone. A finger cap may be used for sliding on a finger of a user and then used on the on-demand workspace. A pressure sensor at the end of the finger cap registers a mouse click. The finger cap may also be used to track movements of the user. The computer is used to project an image on the smartphone view screen that appears to extend beyond the smartphone and thus presenting to the user an enlarged virtual image of a monitor or other picture. A headset may be employed on the user's head. The headset has a compartment to hold the smartphone so that when the headset is worn, the user can see the view screen of the smartphone.

### Technical Problem

The current state of mobile computing technology goes as far as the laptop and the smartphone. Each device has limitations in its use. A small, tissue-box size portable system is needed utilizing a virtual monitor projected from a smartphone and a virtual keyboard projected on a self-stiffening roll-out flexible mat.

The laptop is somewhat bulky relative to the smartphone. While its basic functionality makes it adequate for internet browsing, computing tasks, and office work, its lack of a traditional mouse makes it inadequate for most forms of gaming.

Most games require fast reactions and precise control achievable only with one hand on a mouse and another on a keyboard, whereas the touchpad that comes with most laptops requires two hands; one to guide the cursor, the other to click. Should the user bring an attached mouse, he or she will then need a hard surface to place the mouse so the mouse will function. In situations such as when seated on a crowded bus or subway, it is impossible to find a flat, hard surface needed for proper mouse function.

A smartphone is portable to the point where one can simply slip it into one's pocket when one is finished with it. However, due to its size, it lacks many functions compared to a laptop. A smaller screen limits the software to simpler applications that the user can see. Without a keyboard, users cannot swiftly input text information via typing. While the smartphone often comes with a built-in software keyboard, touch-to-type is much slower than traditional typing. A lack of a mouse limits precision control. While the smartphone also possesses the connectivity functions of a phone; calling, texting, etc. it is highly limited compared to a laptop in computing tasks.

### Solution to Problem

The solution is a portable virtual-reality interactive system that when deployed, will possess enhanced functionality when compared to a laptop computer. When stored, the system will only take up the space of roughly a tissue box. The system does this by taking advantage of virtual reality (VR), projection, tactile sensor, and electromagnetic technology. It is composed of 4 main components: the smartphone serving to enable a virtual-reality display, the computer or processor box, a projector, and the flexible roll-up mat capable of stiffening and serving as the base of a keyboard and optionally as a tactile mouse-pad.

The virtual-reality display operates with or without headgear. The optional headgear fits around the user's eyes like an eyepiece and uses virtual-reality software to project the illusion of a computer monitor a few feet from the user.

The computer or processor box contains typical computer components such as processors, RAM, data storage, and video cards to supplement the processing power of a smartphone and provide laptop computer functionalities. In addition, it optionally comes with one or more USB ports in case the user wishes added functionality.

The roll-up mat serves as location for projecting an image of a keyboard and it may also include a portion devoted to on-demand workspace or mouse pad. The roll-up mat uses electromagnets to stiffen a roll of fabric into a flat, hard surface. Once activated, the projector projects a virtual keyboard onto the mat surface. In addition, at least one finger-cap, preferably two finger-caps, with pressure pads on the tips are storable by attaching them to the fabric. The finger-cap, as a supplement to the contact-sensitive touch-pad portion of the fabric, may be functional to track the user's movements and move a mouse cursor on the smartphone. The pressure pads on the tips serve as mouse-click inputs.

### Advantageous Effects of Invention

The portable virtual-reality interactive system is a device with enhanced functionality of a traditional laptop computer having a large virtual monitor, a virtual keyboard that may be displayed on a flexible roll-up mat and an on-demand workspace on the same flexible mat, which all can be packed into the space of a tissue box. Such a system would enable desktop performance in a portable system.

### BRIEF DESCRIPTION OF DRAWINGS

The drawings illustrate preferred embodiments of the portable virtual-reality interactive system according to the disclosure. The reference numbers in the drawings are used consistently throughout. New reference numbers in FIG. 2 are given the 200 series numbers. Similarly, new reference numbers in each succeeding drawing are given a corresponding series number beginning with the figure number.

FIG. 1 is an illustration of components in a preferred embodiment of the portable virtual-reality interactive system disclosed herein.

FIG. 2 is an exploded view of a representative computer.

FIG. 3 is a sectional view of a flexible roll-up mat showing an embedded wire surrounded by a coil.

FIG. 4 is an exploded view of the coil and wire.

FIG. 5 is an exploded view of a finger cap and user's finger.

FIG. 6 is a perspective of optional headgear.

FIG. 7 is a front view of a person wearing the optional headgear.

FIG. 8 is a perspective of two alternative finger caps showing the pressure pad from the side.

FIG. 9 is a perspective of a preferred embodiment of the portable virtual-reality interactive system in a stowed configuration.

### DESCRIPTION OF EMBODIMENTS

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural, and operational changes may be made, without departing from the scope of the present invention.

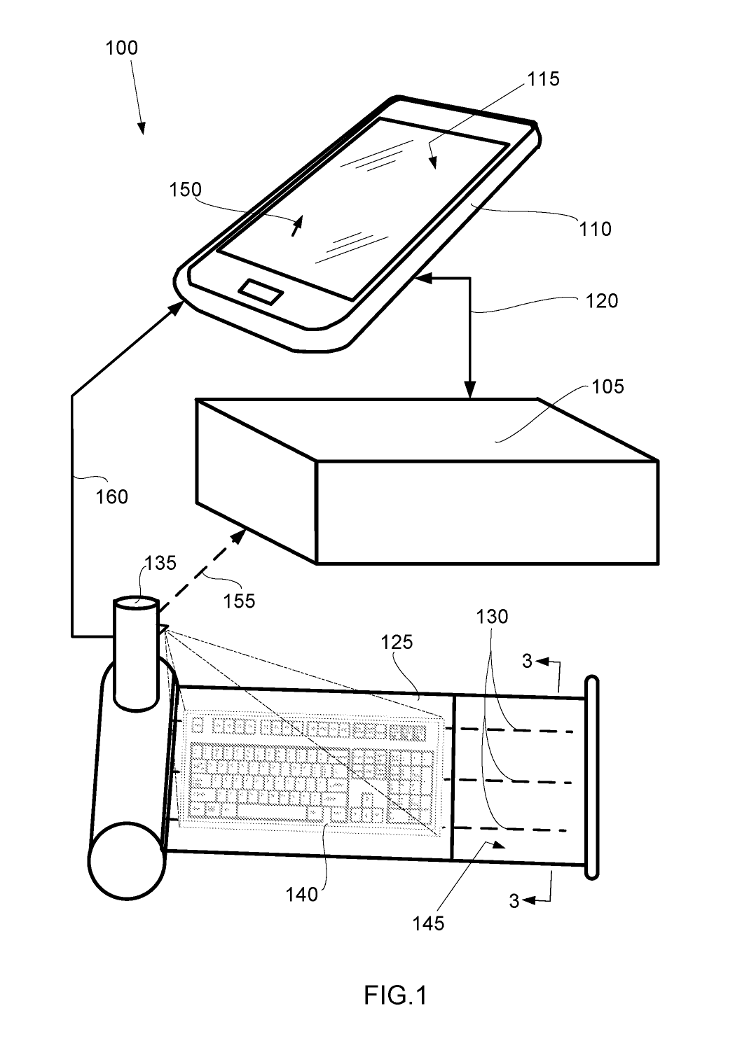

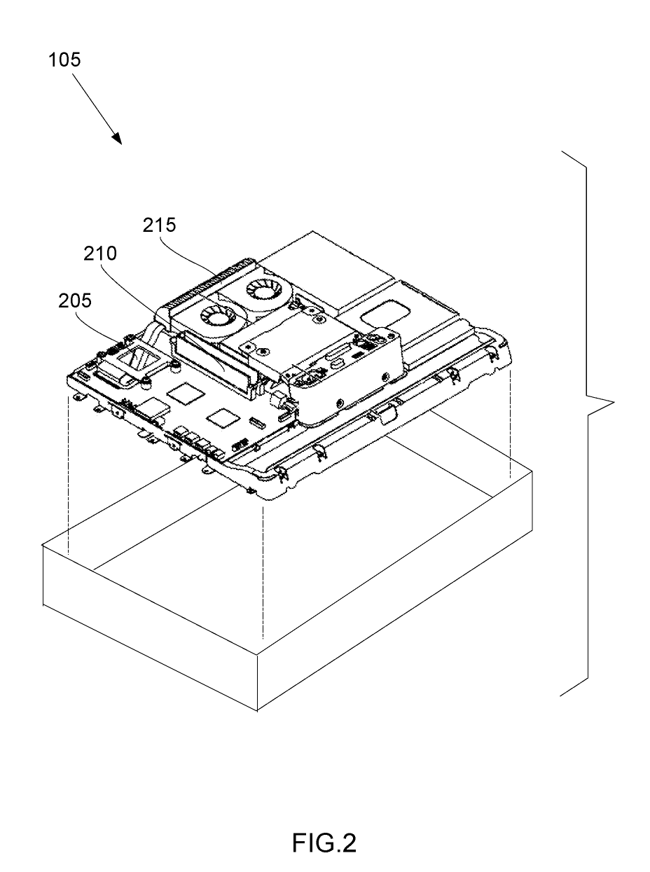

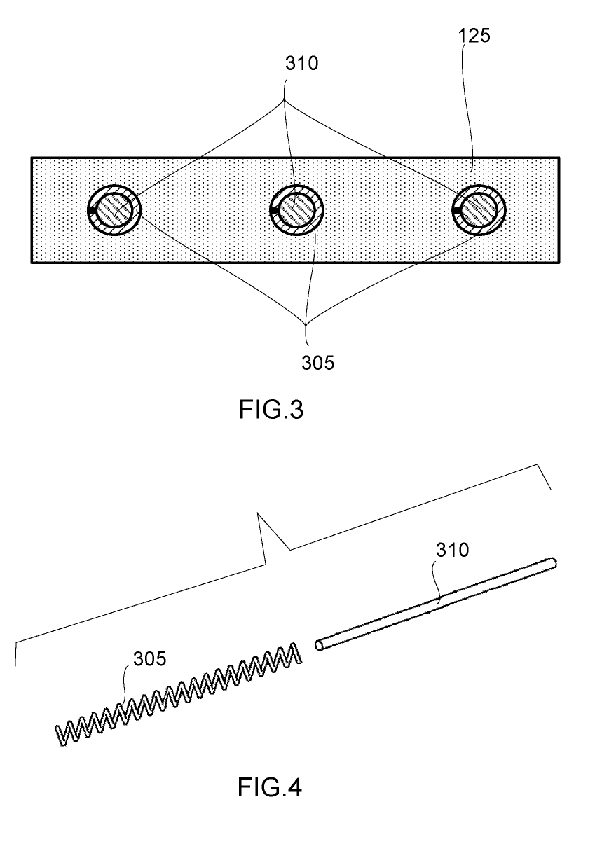

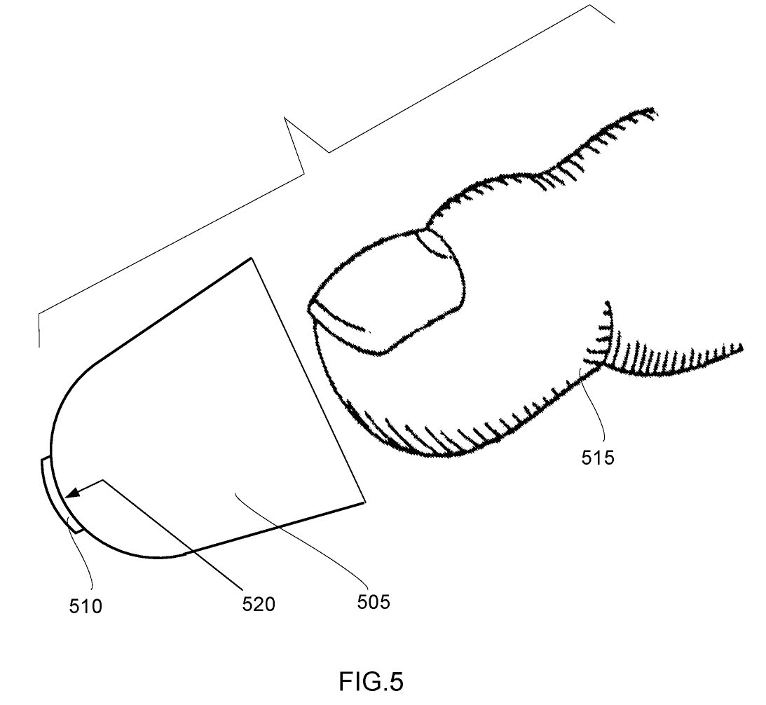

A preferred embodiment of the portable virtual-reality interactive system (100) is illustrated in FIG. 1. The portable virtual-reality interactive system (100) includes a computer (105); a smartphone (110); a flexible roll-up mat (125); and a projector (135).

The computer (105) is any digital computer, such as for example a laptop or desk top computer. The computer preferably includes, but is not limited to a processor (205), non-transitory computer memory (210), and a video card (215). The computer (105) optionally includes a USB port and a power port for charging any component in the portable virtual-reality interactive system (100).

The processor (205) is also referred to as a central processing unit (CPU). It is the electronic circuitry within a computer that carries out the instructions of a computer program by performing the basic arithmetic, logical, control and input/output (I/O) operations specified by the instructions.

The non-transitory computer memory (210) is any of hardware components that may be used to store date for the computer (105) use. Non-transitory computer memory (210) is not intended to include transitory signals. In this application, non-transitory computer memory (210) refers to the computer hardware devices used to store information for immediate use in the computer (105). Non-transitory computer memory (210) is both “primary storage” and “secondary storage.”

The non-transitory computer memory (210) that is “primary storage” or “main memory,” preferably includes addressable semiconductor memory, i.e. integrated circuits consisting of silicon-based transistors. There are two main kinds of semiconductor memory, volatile and non-volatile. Examples of non-volatile memory are flash memory (used as secondary memory) and Read Only Memory (ROM), Programmable Read Only Memory (PROM), EPROM and Electrically Erasable Programmable Read-Only Memory (EEPROM) memory (used for storing firmware such as BIOS). Examples of volatile memory are primary storage, which is typically Dynamic Random-Access Memory (DRAM), and fast CPU cache memory, which is typically Static Random-Access Memory (SRAM) that is fast but energy-consuming, offering lower memory areal density than Dynamic Random-Access Memory (DRAM).

The non-transitory computer memory (210) that is secondary storage preferably includes devices such as hard disk drives and solid-state drives.

The smartphone (110) is a mobile phone and computer with an advanced mobile operating system that combines features of a personal computer operating system with other features useful for mobile or handheld use. The smartphone (110) can implement software commands. The smartphone (110) preferably includes a view screen (115). The view screen (115) is preferably a color graphical user interface screen that covers 70% or more of the front surface, with a Liquid Crystal Display (LCD), Organic Light Emitting Diode (OLED), Active-Matrix Organic Light-Emitting Diode (AMOLED), Light-Emitting Diode (LED), or similar screen.

The smartphone (110) is preferably configured for interoperability (120) with the computer (105). The interoperability (120) preferably includes the capability that the smartphone (110) and computer (105) together can cooperate on executing software.

Interoperability (120) preferably includes the ability to send data, including images, from the computer (105) to the smartphone (110) for display on the view screen (115). The interoperability (120) of the smartphone (110) and computer (105) preferably includes an ability of the computer (105) to project an image (140) on the view screen (115) that appears to extend beyond the smartphone (110), that is, to extend behind the view screen (115) and further away from the user (705). In one example, the image (140) may be that of a computer monitor that functions as a physical computer monitor would function. This would enable the portable virtual-reality interactive system to function much in the same way as a desktop computer. In another example, the image (140) may be a video game that enables larger than life user participation.

Projecting an image (140) on the view screen (115) that appears to extend beyond the smartphone (110) is a virtual reality feature. Interoperability (120) also preferably includes the ability of the smartphone (110) to send data or commands to the computer (105), for example, user-selected commands, for implementation or storage by the computer (105).

The flexible roll-up mat (125) is preferably stored on a spring-loaded roller within a cylindrical container and pulled-out, that is, extended from the cylindrical container, when needed. When rolled-up, the flexible roll-up mat (125) preferably occupies a space equivalent to an elongated pill bottle. The flexible roll-up mat (125) is preferably stored in the cylindrical container that is about two to four inches in circumference and about six to eight inches in height. The flexible roll-up mat (125) is preferably made of a synthetic fabric that can survive being pulled from its cylindrical container.

The flexible roll-up mat (125) includes a stiffening mechanism (130) configured for electrical activation. Thus, stiffening mechanism (130) is preferably connected to a battery that may be turned on or off, or has a plug-in receptacle for traditional alternating current access.

The stiffening mechanism (130) preferably includes a plurality of embedded coils (305) where each embedded coil in the plurality of embedded coils (305) surrounds a flexible electrical wire (310). Such flexibility preferably includes a 14-gauge or thinner electrical wire. Each embedded coil in the plurality of embedded coils (305) is essentially wrapped around the flexible electrical wire (310). Because each wire and coil combination are embedded in the flexible roll-up mat (125), electrical stimulation of each embedded coil in the plurality of embedded coils (305) causes the flexible electrical wire (310) surrounded by that coil to exert force extending and stiffening the flexible roll-up mat (125) in a deployed, or unrolled, position. Each of the embedded coils in the plurality of embedded coils is essentially an electromagnet that when energized, creates a magnetic field around the embedded wire in an axial direction, causing each wire to straighten out and stiffen the flexible roll-up mat (125). Preferably, when the plurality of embedded coils (305) is energized, the projector (135) simultaneously displays the image (140) of the keyboard. Preferably, the image (140) of the keyboard is an infrared keyboard projected on about three-fourths the flexible roll-up mat (125) that is in a stiffened state.

The projector (135) is an image projector. The projector (135) is preferably configured to project an image (140) of a keyboard on the flexible roll-up mat (125) when the flexible roll-up mat (125) is unrolled.

The projector (135) is a module roughly the size of a large pill bottle. The module first projects the image (140) of a keyboard onto a flat non-reflective surface using a diode laser and a Diffractive Optical Element. The Diffractive Optical Element contains a tiny image of a keyboard. The laser shines through the Diffractive Optical Element to project the image (140) of a keyboard onto the surface. Near the bottom of the projector (135) is an infrared laser diode which projects a plane of infrared light millimeters above the visible light image. When a user taps the keys a CMOS (complementary metal-oxide semiconductor), images of the position of the user's fingers within the area of the keyboard and a special sensor chip called a Virtual Interface Processing Core analyze the location of the intended keystroke. The projector (135) then sends this information to the smartphone (110) or the computer (105) receiving the commands.

Thus, the projector (135) contains all the functionality required to simulate a functional keyboard, requiring only a hard surface provided by the flexible roll-up mat (125) and no specialty wiring. The projector (135) function would be exactly the same if given a table or counter. Thus, the flexible roll-up mat (125) need contain no sensors or circuits to detect touch.

Preferably, the flexible roll-up mat has no functionality beyond stiffening and providing a hard surface; both the projected keyboard and the finger-cap (505) only require a hard surface to operate from, but nothing more.

In an alternative embodiment, the mat contains touch sensors to track user input and the necessary keyboard markings, so that the user can know where to press for each keystroke. For this embodiment, only a small processing unit is additionally necessary to relay key press information. This alternative embodiment is not the best mode of the invention because such a configuration of wiring and touch sensors in a thin, flexible mat has the potential to be fragile and require frequent replacement.

The flexible roll-up mat (125) may be configured so that a portion of the flexible roll-up mat (125) provides an on-demand workspace (145) for the user. Preferably, the flexible roll-up mat (125) does not have any advanced contact functionality.

The on-demand workspace (145) is to the right of the image (140) of the keyboard occupying about one-fourth of the surface of the flexible roll-up mat (125). For left handed users, the on-demand workspace (145) may be located to the left of the keyboard. In yet other embodiments, the flexible roll-up mat (125) may be configured by the user (705) to place the image (140) of the keyboard and the on-demand workspace (145) wherever desired by the user (705).

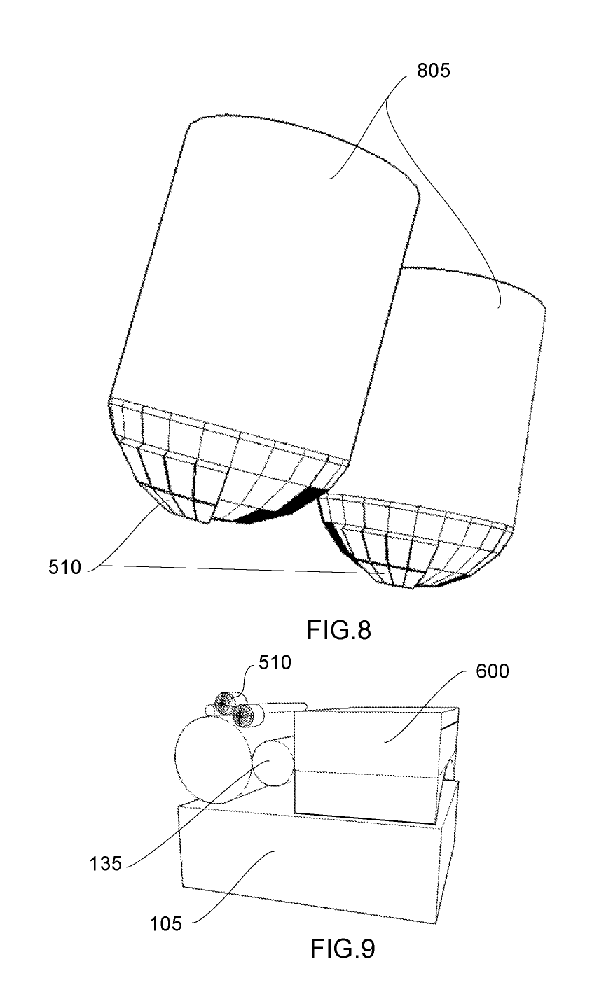

The portable virtual-reality interactive system (100) may include a finger cap (505) configured for sliding on a finger (515) of a user (705) and further configured for use on the on-demand workspace (145). Preferably, there are two finger caps. FIG. 8 illustrates one example of alternate finger caps (805). Each preferred finger cap (505) or each of the alternate finger caps (805) includes a pressure sensor (510) at a distal end (520) of the finger cap (505). The pressure sensor (510) is configured to register downward pressure on the pressure sensor (510) as a mouse click. The finger cap (505) may be further configured to track movements of the user (705) in a manner similar to that used on smartphones in tracking the movement of the smartphone.

The finger cap (505) further includes a contact sensor for recognizing directional drag similar to how a laser mouse works. Thus the on-demand workspace (145) on the flexible the roll-up mat (125) does not require any advanced contact functionality.

When two finger caps are employed, there is preferably a primary finger cap on the user's index finger and a secondary finger cap on the user's middle finger. To guide the mouse cursor shown on the view screen (115), the user would touch the primary cap to the on-demand workspace (145), i.e., that part of the flexible roll-up mat (125) dedicated for that purpose and then drag the one of the finger caps across the surface in the direction the user wishes to move the mouse cursor. To click, the user (705) would, for example, press the primary cap to the surface of the on-demand workspace (145) so that the pressure pad “clicks” and registers a click to the system. To “right-click,” the user (705), for example, would do the same action with the secondary finger cap on his or her middle finger. In order to replicate the function of the middle scroll wheel, the finger cap (505) may be configured so that the user (705) would contact the on-demand workspace (145) with the secondary cap and drag it in the direction the user (705) wanted to scroll.

The portable virtual-reality interactive system (100) will function simply bholding the smartphone (110) in front of the user's eyes, or by sitting it on a table in front of the user. However, other embodiments include a headset (600) that enhances viewability.

Thus, the portable virtual-reality interactive system (100) may include a headset (600) configured to be worn on the user's head and containing a compartment (605) for the smartphone (110) so that when the headset (600) is worn, the user (705) can see the view screen (115) of the smartphone (110). A compartment (605) contained in the headset (600) holds the smartphone (110) in a fixed position relative to the user (705). The headset (600) can improve the virtual reality sensation by steadying the smartphone (110) and cutting down on light sources that might otherwise obscure the view screen (115) virtual reality effect.

The headset (600) may also be referred to as an eyepiece box and may be a simple or a complex device. For example, the headset (600) may be made of cardboard or a similar material. The compartment (605) in the headset (600) that holds the smartphone (110) preferably has similar width, depth and height dimensions as the smartphone (110). The headset (600) is preferably constructed to be as easily wearable as sunglasses or headphones.

The headset (600) is preferably a small box. However, the view screen (115) of the smartphone (110) provides the perception of a full computer monitor. Virtual reality software can simulate a computer monitor that, for example, is two feet in front of the user (705). If the user (705) moves his or her head, the projected monitor will seem to float in its same position in virtual space, allowing the user (705) to look around the projected monitor.

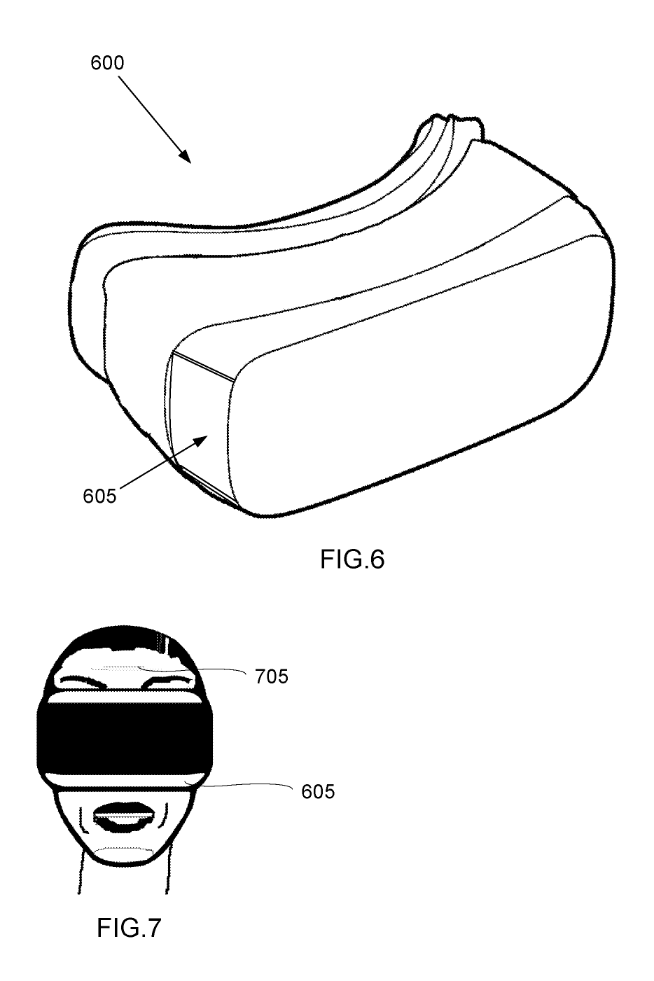

In one embodiment, the headset (600) shown in FIG. 9, the left, upper, and right edges facing the user are extended to fit around the user's temples and reduce external light. A headset (600) that is contoured is shown in FIG. 6. A contour enables the headset (600) to fit snugly against the user's face. Preferably, the middle of the bottom edge of the face facing the user (705) is cut away to fit the bridge of the user's nose.

The headset (600) may include a lens at each eye position to facilitate viewing. The smartphone (110) fits into the headset (600) on the side distant from the eye holes or lenses. The view screen (115) of the smartphone (110) faces the user's eyes. Finally, there is preferably a strap that fits around the user's head to keep the headset (600) attached to the user's head and comfortably positioned for looking at the view screen (115).

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

### INDUSTRIAL APPLICABILITY

The invention has application to the computer industry.

What is claimed is:

1. A portable virtual-reality interactive system comprising:
a computer comprising a processor, non-transitory computer memory, and a video card;
a smartphone comprising a view screen, the smartphone configured for interoperability with the computer;
a flexible roll-up mat comprising a stiffening mechanism configured for electrical activation;
the stiffening mechanism comprising a plurality of embedded coils, each embedded coil in the plurality of embedded coils surrounding a flexible electrical wire; and
a projector configured to project an image of a keyboard on the flexible roll-up mat when the flexible roll-up mat is unrolled, the flexible roll-up mat configured to recognize contact with individual keyboard keys shown in the image for entering data into the smartphone.

2. The portable virtual-reality interactive system of claim 1, wherein the flexible roll-up mat further comprises a portion thereof configured to serve as an on-demand workspace for controlling a cursor on the smartphone.

3. The portable virtual-reality interactive system of claim 2, further comprising a finger cap configured for sliding on a finger of a user and further configured for use on the on-demand workspace, the finger cap comprising a pressure sensor at a distal end of the finger cap, the pressure sensor configured to register downward pressure on the pressure sensor as a mouse click.

4. The portable virtual-reality interactive system of claim 3, wherein the finger cap is configured to track movements of the user.

5. The portable virtual-reality interactive system of claim 1, wherein the interoperability of the smartphone and computer comprises an ability of the computer to project an image on the view screen that appears to extend beyond the smartphone.

6. The portable virtual-reality interactive system of claim 1, further comprising a headset configured to be worn on a user's head and containing a compartment for the smartphone so that when the headset is worn, a user can see the view screen of the smartphone.

7. The portable virtual-reality interactive system of claim 6, wherein the compartment contained in the headset holds the smartphone in a fixed position relative to the user.

8. The portable virtual-reality interactive system of claim 1, wherein the flexible roll-up mat is further configured to recognize contact with individual keyboard keys shown in the image for input to the computer.
